(19) United States
(12) Patent Application Publication
(10) Pub. No.: US 2021/0015139 A1
(43) Pub. Date: Jan. 21, 2021

(54) ROASTING DRUM OF A COFFEE BEAN ROASTER

(71) Applicant: GRAND MATE CO., LTD., Taichung City (TW)

(72) Inventors: CHUNG-CHIN HUANG, Taichung City (TW); Chin-Ying Huang, Taichung City (TW); Hsin-Ming Huang, Taichung City (TW); Hsing-Hsiung Huang, Taichung City (TW); Yen-Jen Yeh, Taichung City (TW); Kuan-Chou Lin, Taichung City (TW); Shao-Feng Huang, Taichung City (TW)

(73) Assignee: GRAND MATE CO., LTD., Taichung City (TW)

(21) Appl. No.: 16/516,024

(22) Filed: Jul. 18, 2019

(51) Int. Cl. A23N 12/10

(52) U.S. Cl. CPC A23N 12/10

(57) ABSTRACT

A roasting drum of a coffee bean roaster including a drum body, an end plate and a plurality of guide vanes. The end plate is coupled to an end of the drum body and has a plurality of through holes communicating with an inside and an outside of the drum body, each of the through holes is elongated and extends along a radial direction of the end plate. The guide vanes are connected to the end plate and disposed respectively at one side of the through holes. With the flow guiding of the guide vanes, the airflow inside the roasting drum of the coffee bean roaster is efficiently accelerated.

### BACKGROUND OF THE INVENTION

### Technical Field

The present invention is related to a roasting drum of a coffee bean roaster, and more particularly to a roasting drum with guide vanes.

### Description of Related Art

It is known that the coffee bean roaster is for roasting green coffee beans. Since green coffee beans produce a lot of chaff during the roasting process, the coffee bean roaster is usually provided with an exhaust device for discharging chaff and for adjusting the roasting temperature by controlling the airflow.

A conventional coffee bean roaster comprises a roasting drum, a heating device, a driving device, and an exhaust device. The roasting drum is for accommodating green coffee beans, the heating device disposed under the roasting drum is for heating green coffee beans in the roasting drum, the driving device is for driving the roasting drum to rotate so the green coffee beans in the roasting drum are heated uniformly, and the exhaust device such as an air blower is for discharging air inside the coffee bean roaster to the outside.

Though the above coffee bean roaster can achieve the purpose of roasting green coffee beans, there are still drawbacks thereof. The coffee bean roaster uses only one air blower to discharge air, resulting in the disadvantages of being not able to guide airflow rapidly. Therefore, the exhaust of the coffee bean roaster needs to be improved.

### BRIEF SUMMARY OF THE INVENTION

In view of the above, a purpose of the present invention is to provide a roasting drum of a coffee bean roaster that is able to accelerate the flow of the airflow.

The present invention provides a roasting drum of a coffee bean roaster, including a drum body, an end plate and a plurality of guide vanes. The end plate is coupled to an end of the drum body, wherein the end plate has a plurality of through holes communicating with an inside and an outside of the drum body, each of the through holes being elongated and extending along a radial direction of the end plate. The guide vanes are connected to the end plate and are disposed respectively at one side of the through holes.

The advantage of the present invention is to accelerate the flow of the airflow in the roasting drum of the coffee bean roaster by the guide vanes guiding the flow.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a perspective view of a roasting drum of a coffee bean roaster of a first embodiment;

FIG. 2 is an exploded view of the roasting drum of the first embodiment;

FIG. 3 is another perspective view of the roasting drum of the first embodiment;

FIG. 4 is a front view of an end plate of the first embodiment;

FIG. 5 is a partial cross-sectional schematic view of FIG. 1 along lines 5-5;

FIG. 6 is a cross-sectional schematic view of the coffee bean roaster of the first embodiment;

FIG. 7 is a schematic view showing that the guide vanes guide the airflow when the roasting drum rotates; and

FIG. 8 is a perspective view of a roasting drum of a coffee bean roaster of a second embodiment.

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification.

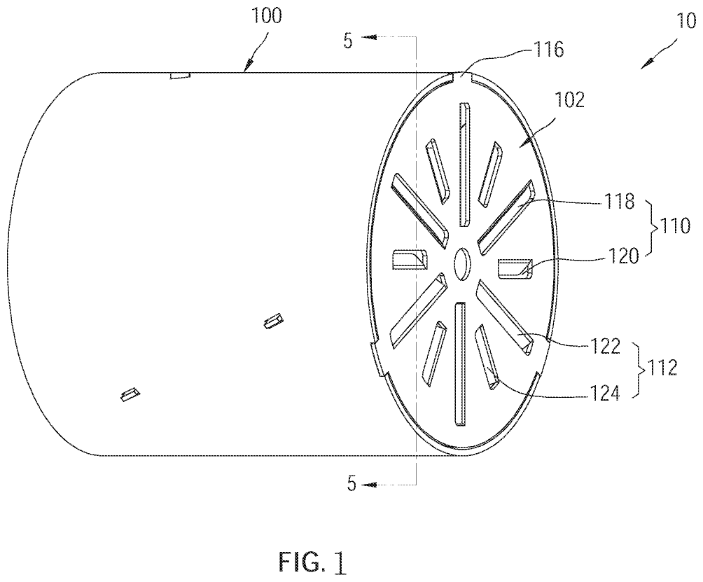

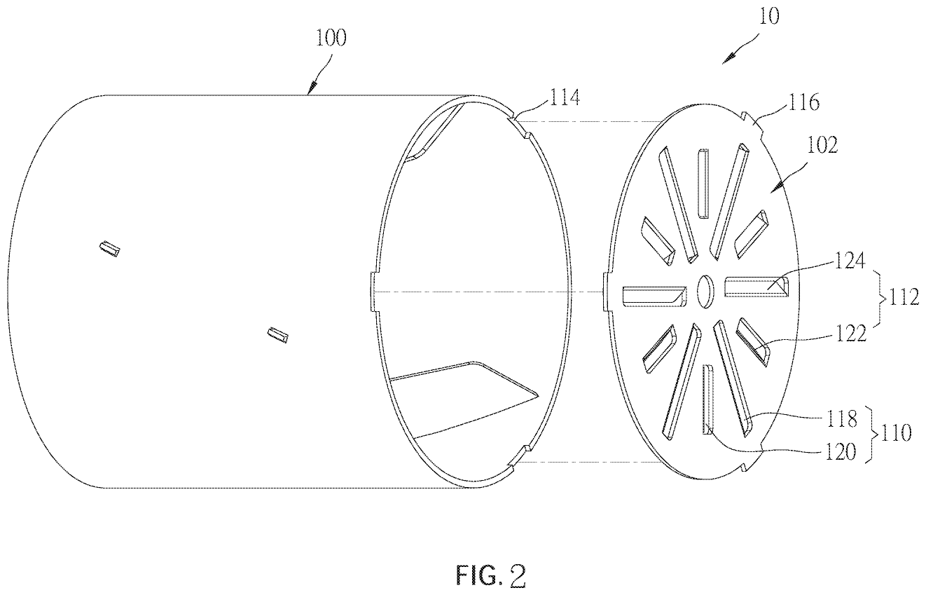

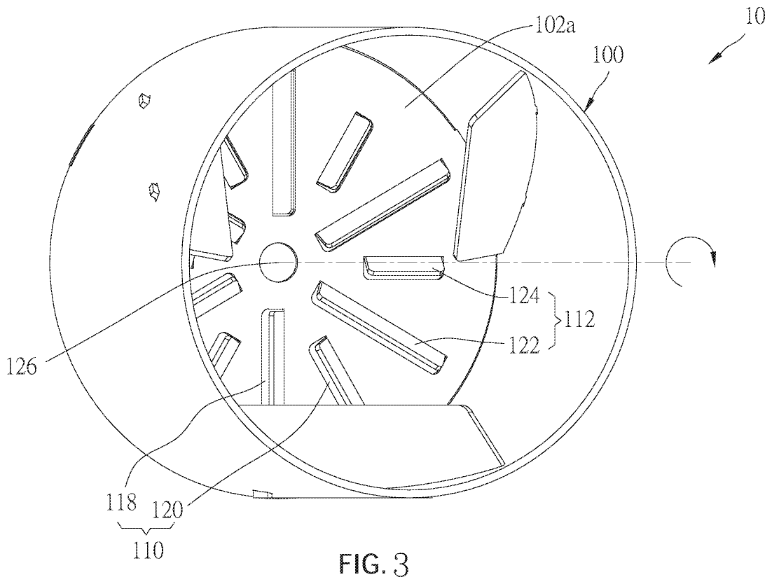

FIG. 1 to FIG. 5 show a roasting drum 10 of a first embodiment according to the present invention, including a drum body 100, an end plate 102 coupled to an end of the drum body 100, and a plurality of guide vanes 112. The end plate 102 has a plurality of through holes 110. The through holes 110 communicate with an inside and an outside of the drum body 100, and each of the through holes 110 is elongated and extends along a radial direction of the end plate 102. The guide vanes 112 are connected to the end plate 102 and are disposed respectively at one side of the through holes 110. The air flows between the inside and the outside of the drum body 100 via the through holes 110.

In the current embodiment, the end plate 102 is a circular plate and the drum body 100 is a cylinder. The end plate 102 is fixed to the drum body 100 such as by welding. In other embodiments, the means of detachably coupled to the drum body 100 is taken into consideration. More specifically, in the current embodiment one end edge of the drum body 100 has a plurality of recesses 14 and the end plate 102 has a plurality of protrusions 116 that fit the recesses 114, namely that each of the protrusions 116 of the end plate 102 can respectively engage with the corresponding one recess 114 of the drum body 100, which has the effect of easy positioning.

The end plate 102 and the guide vanes 112 are formed integrally so that the guide vanes 112 are stably attached to the end plate 102 and are not easily separated from the end plate 102. In the current embodiment, the end plate 102 and the guide vanes 112 are stamped out of a plate body, and no additional connecting process or additional connecting members are needed between the end plate 102 and the guide vanes 112. In other embodiments, the end plate 102 and the guide vanes 112 can be attached by welding or the guide vanes 112 can be fixed to the end plate 102 by connecting members, without limited to the above integrally forming.

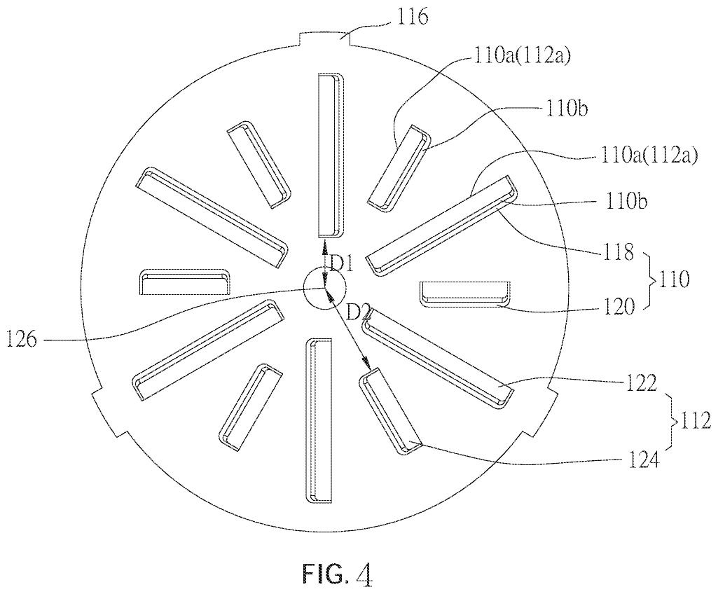

As illustrated in FIG. 4, a peripheral edge of each of the through holes 110 has a first long side 110a and a second long side 110b positioned at opposite ends. Each of the guide vanes 112 is elongated and has two long sides 112a positioned at opposite ends, one of the two long sides 112a of each guide vane is connected to the corresponding first long side 110a of the peripheral edge of each through hole 110, and a long axis of each of the guide vanes 112 is parallel to that of a corresponding one of the through holes 110. In the current embodiment, the through holes 110 and the guide vanes 112 are both elongated; in practice, the shapes of the through holes 110 can be different from those of the guide vanes 112, such as semicircular guide vanes being attached to one side of elliptical through holes.

It is worth mentioning that the through holes 110 include a plurality of first through holes 118 and a plurality of second through holes 120, each of the first through holes 118 is located between two corresponding second through holes 120, and a length of each of the first through holes 118 is greater than that of each of the second through holes 120. The guide vanes 112 include a plurality of first guide vanes 122 and a plurality of second guide vanes 124, a length of each of the first guide vanes 122 is greater than that of each of the second guide vanes 124, each of the first guide vanes 122 is attached to a peripheral edge of a corresponding first through hole 118, each of the second guide vanes 124 is attached to a peripheral edge of a corresponding second through hole 120, and the through holes 110 are disposed respectively along different radial directions of the end plate 102.

The end plate 102 has a central point 126, a shortest distance between each of the first through holes 118 and the central 126 is a first distance D1, a shortest distance between each of the second through holes 120 and the central point 126 is a second distance D2, and the first distance D1 is less than the second distance D2. Since the first through holes 118 and the second through holes 120 disposed at different distances from the central point 126 are staggered with each other, the plurality of through holes 110 can be disposed on the end plate 102, which has the effect of efficiently utilizing the area of the end plate 102.

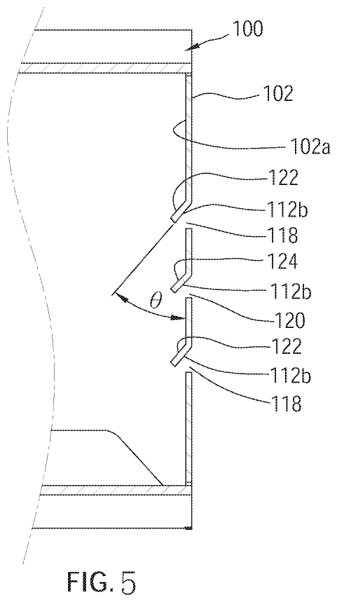

As illustrated in FIG. 5, the end plate 102 has a surface 102a, a short axis of each of the guide vanes 112 extends along a direction away from the surface toward an outer side thereof, each of the guide vanes 112 has a guiding surface 112b facing a corresponding one of the through holes 110, and a projection range of each of the guide vanes 122 with respect to the surface 102a of the end plate 102 covers a part of each of the corresponding through holes 110. An angle θ is formed between each of the guiding surfaces 112b and the surface 102a, and the angle θ is 35-55 degrees. The surface 102a of the end plate 102 faces an inside of the drum body 100 and the guide vanes 112 are disposed inside the drum body 100.

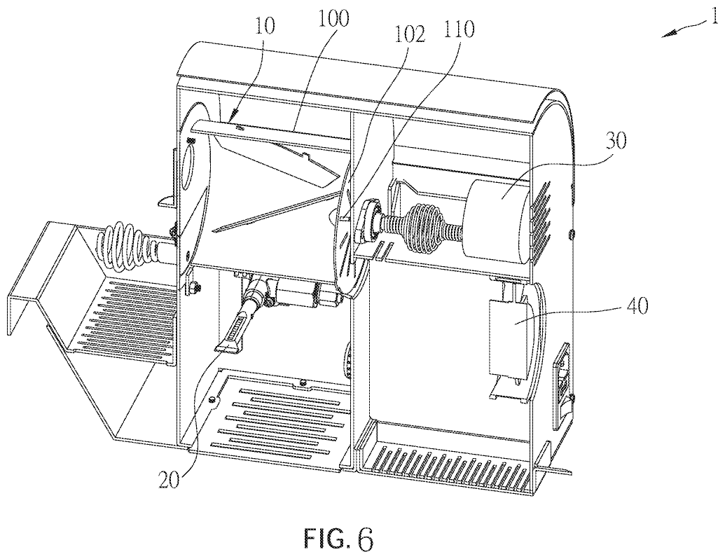

FIG. 6 shows a schematic view of a coffee bean roaster 1 with the above roasting drum 10, wherein the coffee bean roaster 1 further includes a heating device 20, a driving device 30 and an exhaust device 40. The roasting drum 10 is for accommodating green coffee beans and is connected to the driving device 30, the heating device 20 disposed below the roasting drum 10 is for generating fire to heat the green coffee beans in the roasting drum 10, the driving device 30 is for driving the roasting drum 10 to rotate so the green coffee beans in the roasting drum 10 are heated uniformly, and the exhaust device 40 is for discharging air inside the coffee bean roaster 1.

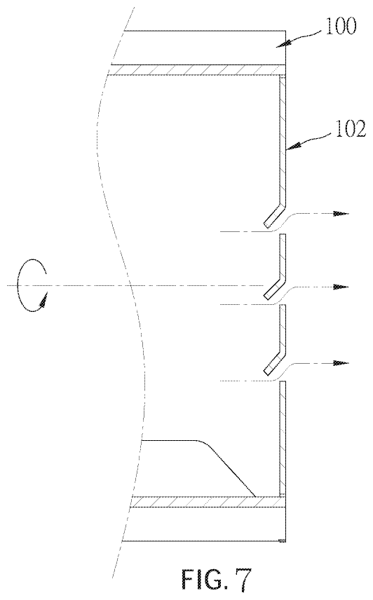

When the roasting drum 10 rotates around the axis, the plurality of the guide vanes 112 disposed at one side of the through holes 110 of the drum body 100 disturb air in the drum body 100, so that the airflow as shown in FIG. 7 is discharged from the inside of the drum body 100 through the through holes 100 and then discharged from the coffee bean roaster 1 through the exhaust device 40. The airflow is accelerated to be discharged from the inside of the drum body 100 through the through holes 110.

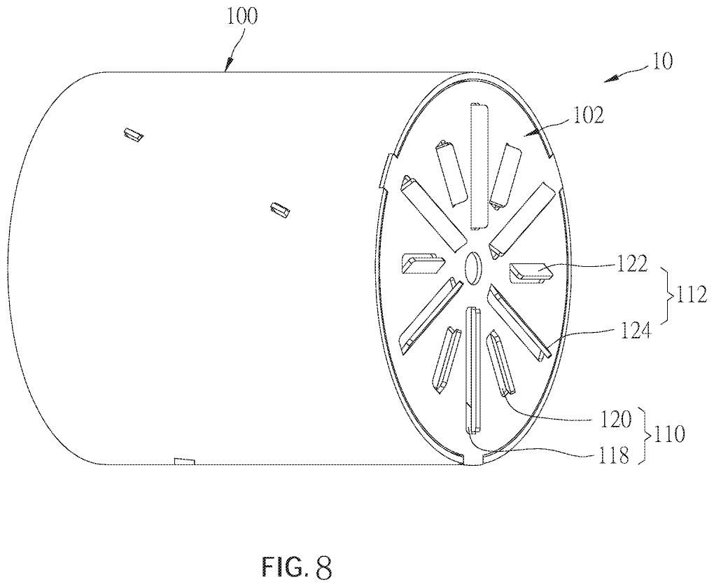

A roasting drum 10 of a coffee bean roaster of a second preferred embodiment according to the present invention is shown in FIG. 8. The roasting drum 10 includes a structure which is similar to that of the first preferred embodiment, except that the surface 102a of the end plate 102 faces away from the inside of the drum body 100 and the guide vanes 112 are disposed outside the drum body 100. The roasting drum 10 of the current embodiment guides the airflow during rotation, such as guiding the external airflow into the inside of the drum body 100.

With guide vanes guiding the air flow, the airflow inside the roasting drum of the coffee bean roaster is efficiently accelerated.

It must be pointed out that the embodiments described above are only some embodiments of the present invention. All equivalent structures which employ the concepts disclosed in this specification and the appended claims should fall within the scope of the present invention.

What is claimed is:

1. A roasting drum of a coffee bean roaster, comprising:
a drum body and an end plate coupled to an end of the drum body, wherein the end plate has a plurality of through holes communicating with an inside and an outside of the drum body, each of the through holes being elongated and extending along a radial direction of the end plate; and
a plurality of guide vanes connected to the end plate and disposed respectively at one side of the through holes.

2. The roasting drum of the coffee bean roaster of claim 1, wherein the end plate and the guide vanes are formed integrally.

3. The roasting drum of the coffee bean roaster of claim 2, wherein a peripheral edge of each of the through holes has a first long side and a second long side positioned at opposite ends; each of the guided vanes is elongated and has two long sides positioned at opposite ends, one of the two long sides of each guide vane is connected to the corresponding first long side of the peripheral edge of each through hole.

4. The roasting drum of the coffee bean roaster of claim 3, wherein the end plate has a surface, a short axis of each of the guide vanes extends along a direction away from the surface toward an outer side thereof, and each of the guide vanes has a guiding surface facing a corresponding one of the through holes; an angle is formed between each of the guiding surface and the surface and the angle is 35-55 degrees.

5. The roasting drum of the coffee bean roaster of claim 4, wherein the surface of the end plate faces an inside of the drum body and the guide vanes are disposed inside the drum body.

6. The roasting drum of the coffee bean roaster of claim 4, wherein the surface of the end plate faces away from an inside of the drum body and the guide vanes are disposed outside the drum body.

7. The roasting drum of the coffee bean roaster of claim 3, wherein the through holes include a plurality of first through holes and a plurality of second through holes, each of the first through holes is located between two corresponding second through holes, and a length of each of the first through holes is greater than that of each of the second through holes; the guide vanes include a plurality of first guide vanes and a plurality of second guide vanes, a length of each of the first guide vanes is greater than that of each of the second guide vanes, each of the first guide vanes is attached to a peripheral edge of a corresponding first through hole, and each of the second guide vanes is attached to a peripheral edge of a corresponding second through hole.

8. The roasting drum of the coffee bean roaster of claim 7, wherein the through holes are disposed respectively along different radial directions of the end plate.

9. The roasting drum of the coffee bean roaster of claim 7, wherein the end plate has a central point, a shortest distance between each of the first through holes and the central point is a first distance, a shortest distance between each of the second through holes and the central point is a second distance, the first distance is less than the second distance.

10. The roasting drum of the coffee bean roaster of claim 1, wherein each of the guide vanes is elongated, and a long axis of each of the guide vanes is parallel to that of a corresponding one of the through holes.
